(19) United States
(12) Patent Application Publication
(10) Pub. No.: US 2022/0384811 A1
(43) Pub. Date: Dec. 1, 2022

(54) GRAPHITE COMPOSITIONS AND USES IN BATTERY TECHNOLOGY

(71) Applicant: IMERTECH SAS, Paris (FR)

(72) Inventors: Michael SPAHR, Bellinzona (CH); Hiroyuki TAKI, Tokyo (JP); Hiroyuki MORIOKA, Kanagawa (JP); Xu WANG, Kanagawa (JP); Tsutomu YAHIRO, Kanagawa (JP)

(21) Appl. No.: 17/767,223

(22) PCT Filed: Oct. 7, 2020
(86) PCT No.: PCT/EP2020/078159

§ 371 Date: Apr. 7, 2022

(30) Foreign Application Priority Data
Oct. 7, 2019 (EP) 19306305.4

(51) Int. Cl. H01M 4/587; H01M 10/0525

(52) U.S. Cl. CPC H01M 4/587; H01M 10/0525; H01M 2004/021

(57) ABSTRACT

The present disclosure relates to compositions comprising at least one carbonaceous particulate material comprised of synthetic graphite particles having a BET specific surface area (SSA) of equal to or less than 4 m²/g, and further comprising between about 5 and about 75% (w/w) of at least one carbonaceous particulate material comprised of natural graphite particles coated with non-graphitic carbon and having a BET SSA of equal to or less than 8 m²/g. Such compositions are particularly useful as active material for negative electrodes in, e.g., lithium-ion batteries and the like in view of their overall favorable electrochemical properties, particularly for automotive and energy storage applications. The present disclosure also relates to the use of said non-graphitic carbon-coated natural graphite particles for preparing compositions that are suitable for being used as an active material in a negative electrode of, e.g., a lithium ion battery. The non-graphitic carbon-coated natural graphite particles described herein are also useful as a carbonaceous additive to increase, e.g., the energy density and charge rate performance of a lithium-ion battery while maintaining the power density of the cell compared to a cell with an anode absent the carbonaceous additive.

### FIELD OF THE DISCLOSURE

The present disclosure relates to compositions comprising at least one carbonaceous particulate material comprised of synthetic graphite particles having a BET specific surface area (SSA) of equal to or less than 4 m²/g, and further comprising between about 5 and about 75% (w/w) of at least one carbonaceous particulate material comprised of natural graphite particles coated with non-graphitic carbon and having a BET SSA of equal to or less than 8 m²/g. Such compositions are particularly useful as active material for negative electrodes in, e.g., lithium-ion batteries and the like in view of their overall favorable electrochemical properties, particularly for automotive and energy storage applications.

The present disclosure also relates to the use of said non-graphitic carbon-coated natural graphite particles for preparing compositions that are suitable for being used as an active material in a negative electrode of, e.g., a lithium ion battery. The non-graphitic carbon-coated natural graphite particles described herein are also useful as a carbonaceous additive to increase, e.g., the energy density and charge rate performance of a lithium-ion battery while maintaining the power density of the cell compared to a cell with an anode absent the carbonaceous additive.

### BACKGROUND

Lithium-ion batteries have become the battery technology of choice for consumer electronics like laptop computers, smart phones, video cameras, and digital still cameras. Compared to other battery chemistries, one of the advantages of the lithium-ion battery system relates to the high energy density and specific energy combined with a high power performance due to an average cell voltage of about 3.5 V and the light weight electrode materials. Over the last more than 25 years since the introduction of the first lithium-ion battery by Sony Corp. in 1991, lithium-ion cells have been significantly improved in terms of energy density. This development was inter alia motivated by the increased energy consumption and the trend to miniaturization of the electronic devices that requires decreased accumulator volumes and increased electrochemical cell capacities.

In recent years, lithium-ion batteries have also been considered for automotive applications like hybrid, plug-in, and full electric vehicles, as well as for energy storage systems, for example when integrated into the electric grid in order to buffer peak consumption of electricity in the electric grid and to integrate renewable energy generation like wind and solar energy generation typically being variable in occurrence.

Because batteries used for energy storage applications are mostly stationary battery applications, cell volume and weight are less important compared to other, e.g., mobile applications. On the other hand, the cell durability and the number of charge and discharge cycles with a given capacity retention are important parameters in such applications. This comes along with ensuring the utmost level of battery safety which is an important prerequisite for the proliferation of the lithium-ion cell technology for all desired applications.

For automotive applications the energy of the cell per volume (cell capacity or energy density) and per weight (specific energy) plays an important role for the improvement of the limited driving range, which is still a major obstacle for electric vehicles. At the same time, for reasons of convenience and giving the possibility of reducing the cell capacity, the charging speed as well as the cycling stability and durability of the battery are even more important for such applications than for consumer electronics batteries, not the least due to the significantly higher longevity required by the automotive industry, electricity providers and final users of such batteries.

One important component influencing the electrochemical properties of a lithium-ion cell is the negative electrode (anode). In many lithium-ion batteries, the anode comprises carbonaceous materials such as graphite as an electrochemically active material. Since the carbon material is involved in the electrochemical redox process occurring at the electrodes by intercalating and de-intercalating lithium during the charging and discharging process, respectively, the properties of the carbonaceous material are expected to play an important role in the performance characteristics of the battery. It is well accepted in this technological field that the graphite negative electrode has its limits in terms of charge acceptance and therefore is the main cause of limitations concerning the charging speed, which is an important requirement, especially for automotive lithium-ion batteries.

In practice, lithium-ion batteries for automotive applications should be able to offer high energy density, enabling long driving ranges of at least 300 km (or more). In addition, such batteries should have a high durability, allowing the manufacturers to offer lifetime guarantees of up to 10 years (which is considered to correspond to the lifetime of a car by the industry).

For example, the power density of the batteries should ideally be high enough to enable a capacity retention of 80% after 20 min discharge and a charging speed of about 20 min to a state of charge of 80%.

At the cell level, these desired properties translate into the following requirements of the negative electrode: A high reversible capacity of above about 350 mAh/g and a first cycle coulombic efficiency of more than about 92%. In addition, suitable negative electrodes should exhibit high cycling stability, with at least about 80% capacity retention after 3000 cycles, as well as high charge acceptance and discharge capability at high C rate.

In recent years, special synthetic graphites have taken over as active material for electrode manufacturing, replacing natural graphite-based products due to their generally better cycling performance and lower swelling during electrochemical lithium insertion, giving rise to better cycling properties compared to natural graphite-based electrodes. However, it is rather difficult to obtain good battery durability and at the same time maximize the power and energy, i.e. using graphites with high reversible capacity and high first cycle efficiency typically do not cycle well and usually have low charge acceptance and discharge performance.

Accordingly, while the parallel improvement of all major cell parameters such as energy density, power density, durability, and safety would be desirable, improving one parameter often negatively influences other cell parameters. For example, the energy density typically cannot be increased without losing power density, safety, or durability, or vice versa. Thus, in the cell design and engineering of a lithium-ion battery, the skilled person must usually accept a trade-off between the various cell parameters.

Attempts to address the issues observed for a given graphite active electrode material have been described in the art, including the use of mixtures of different graphite materials to provide graphite compositions exhibiting overall advantageous properties as an electrode active material. For example, WO 2014/024473 A1 (Showa Denko K.K.) describes graphite mixtures as anode active material comprising spherical synthetic graphite in combination with a spherical natural graphite. U.S. Pat. No. 8,728,668 (Nippon Carbon Co., Ltd.) also describes graphite mixtures comprising three different graphites, including synthetic and natural graphites, differing in hardness and shape. EP 2 602 851 B1 similarly describes the use of graphite mixtures comprising artificial (synthetic) and natural graphites for preparing negative electrodes for lithium ion batteries.

It was therefore an object to provide improved graphite compositions useful as an active material in negative electrodes, e.g., in lithium-ion batteries. In particular, there is a continued need in the art for a carbonaceous material with beneficial properties when used as active material in negative electrodes for lithium ion batteries in automotive applications (electric vehicles, etc.), or energy storage applications. Particularly in such applications, it is desirable to improve charging speed, energy density, and charge retention without compromising cycling stability and durability.

### SUMMARY OF THE DISCLOSURE

The present inventors have surprisingly found that the addition of a non-graphitic (e.g. amorphous) carbon-coated natural graphite particulate material to a composition comprising synthetic graphite particles (which are commonly used as active material in negative electrodes, in particular for lithium ion batteries), yields unexpected improvements in terms of fast charging performance of the battery while not negatively affecting the other relevant functional properties of the battery.

In particular, it was found that the addition of said non-graphitic carbon-coated natural graphite to active material compositions for negative electrodes improves the capacity retention of the electrode during the charging process. In addition to the observed higher charging speed, the compositions described herein yield high energy density electrodes characterized by an increased reversible capacity without any significant reduction of the cycling stability. It was also found that at the same binder content in the electrode, the mechanical stability of the electrode (“peeling strength”) was improved as well, leading to a better processability during the electrode manufacturing process.

Accordingly, in a first aspect, the present disclosure relates to a composition comprising at least one carbonaceous particulate material comprised of synthetic graphite particles (“SG”) having a BET SSA of equal to or less than 4 m²/g, and at least one carbonaceous particulate material comprised of natural graphite particles coated with non-graphitic carbon (“cNG”) and having a BET SSA of equal to or less than 8 m²/g. The content of the cNG particles in such compositions is generally between about 5% and about 75%, or between about 10% and about 70%, or between about 15% and about 65%, by weight of the total weight of the composition.

The composition may in some instances also comprise further additives, such as other carbonaceous materials and/or a polymer binder.

Another aspect of the present disclosure relates to a slurry wherein the particles of the composition are dispersed in a liquid such as water. Such slurries are typically used when preparing (negative) electrodes for, e.g., lithium ion batteries.

Yet another aspect of the present disclosure relates to a process for making the compositions described herein, wherein the process comprises mixing a synthetic graphite (“SG”) as defined herein with natural graphite particles coated with non-graphitic carbon (“cNG”) as described herein. Such a mixing may optionally take place in the presence of a liquid/solvent, such as water or a water-based solvent composition (e.g. a water/alcohol mixture).

The use of a natural graphite coated with non-graphitic carbon (“cNG”) as described herein for preparing a composition that is suitable for being used as an active material in a negative electrode represents another aspect of the present disclosure.

In a related aspect, the present disclosure also relates to the use of a natural graphite coated with non-graphitic carbon (“cNG”) as described herein as a carbonaceous additive to increase the energy density and charge rate performance of a lithium-ion battery while maintaining the power density of the battery compared to a battery with a negative electrode absent the carbonaceous additive.

A further aspect relates to the use of the compositions as described herein for preparing a negative electrode of a lithium-ion battery. Such lithium-ion batteries can be used, for example, in an electric vehicle, a hybrid electric vehicle, or an energy storage cell.

Electrodes comprising the compositions described herein as active material thus represent a further aspect of the present disclosure.

Finally, the present disclosure relates to a lithium-ion battery comprising the composition as described herein as active material in the negative electrode of said battery, as well as to an electric vehicle, a hybrid electric vehicle, or an energy storage cell comprising such a lithium-ion battery.

### BRIEF DESCRIPTION OF THE DRAWINGS

FIG. 1 shows an SEM picture for a representative coated natural graphite booster material used in the present disclosure at two different magnifications.

FIG. 2 plots the charge retention values at 2 C in a coin cell test, dependent on the cNG/SG ratio in the composition used as active material in the anode.

FIG. 3 plots the charge retention values at 2 C in a coin cell test for different synthetic graphites with a fixed 10% addition of cNG Booster-1.

FIG. 4 plots the CC charge ratio at 3 C, 5 C and 7 C in a pouch cell test for two different synthetic graphites with a fixed 10 wt % addition of cNG Booster-1 (Panel A: SG2+10% cNG Booster-1, Panel B: SG4+10% cNG Booster-1).

FIG. 5 shows the peel strength of the electrode for electrodes made form compositions with a different cNG content ranging from 0, 20, 30, 40, and 100% cNG Booster-3.

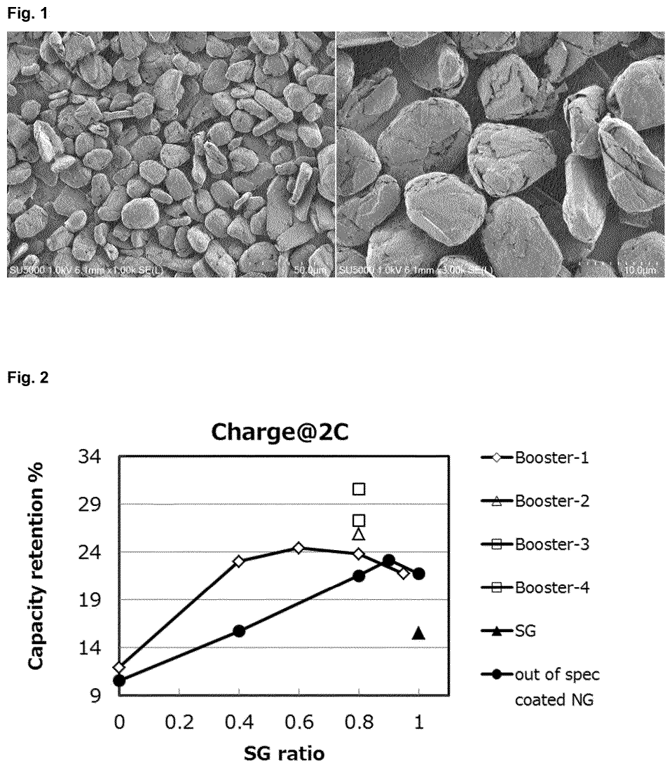

### DETAILED DESCRIPTION

The present inventors have found that the addition of a carefully selected, typically spherical, highly crystalline, natural graphite coated with a layer of non-graphitic (e.g. amorphous) carbon (hereinafter referred to as “cNG”) to a composition comprising synthetic graphite commonly used as an active material in negative electrodes (anodes) of a lithium-ion battery can surprisingly improve the performance characteristics of the battery. In particular, it was found that batteries comprising such compositions including the cNG as active anode material enable higher charging speeds and an increased reversible capacity of the electrode without any significant reduction of the cycling stability of the cell. Moreover, such compositions typically also increase the mechanical stability of the electrode.

Accordingly, a first aspect of the present disclosure relates to a composition comprising:

at least one carbonaceous particulate material comprised of synthetic graphite particles (“SG”) having a BET SSA of equal to or less than 4 m²/g; and at least one carbonaceous particulate material comprised of natural graphite particles coated with non-graphitic carbon (“cNG”) and having a BET SSA of equal to or less than 8 m²/g; wherein the content of the cNG particles is between about 5% and about 75% (w/w, i.e. weight of cNG/total weight of the composition). In some embodiments, the content of the cNG particles is between about 10% and about 70% (w/w).

The term “about”, when used herein in the context of parameters or values, encompasses deviations of +/−10% of the given value, unless stated otherwise.

The synthetic graphite present in the composition can be any synthetic graphite that is suitable for use as active material in negative electrodes. Thus, the synthetic graphite particles in the composition may in some instances be further characterized, apart from having a BET SSA of equal to or less than about 4 m²/g, by one or more of the following parameters (i.e. alternatively or in addition).

In certain embodiments, the synthetic graphite particles may be further characterized by a particle size distribution (PSD) with a D₅₀ of between about 10 μm and about 30 μm. In some embodiments, the PSD D₅₀ value is between about 10 μm and about 25 μm, or between about 10 μm and about 20 μm. The D₉₀ values of the synthetic graphite particles are typically between about 20 μm and about 40 μm.

The synthetic graphite particles may in some embodiments be further characterized by an interlayer distance c/2 of between about 0.3354 nm and about 0.3370 nm.

In certain embodiments, the synthetic graphite particles may have a BET SSA of between about 0.5 m²/g and about 4 m²/g, or between about 1 m²/g and about 3 m²/g, or between about 1 m²/g and about 2 m²/g.

Alternatively or in addition, the synthetic graphite particles may in certain embodiments be characterized by a xylene density of at least about 2.22 g/cm³, or at least about 2.23 g/cm³, or at least about 2.24 g/cm³.

In some embodiments, the synthetic graphite particles have a tap density (after 400 taps) of at least about 0.8 g/cm³; or at least about 0.9 g/cm³, or at least about 0.95 g/cm³.

The synthetic graphite particles may in certain embodiments be further characterized by a ratio of the crystallographic [004] and [110] reflection intensities (“OI”) for a pressed electrode sheet comprising said graphite particles of less than about 50, or less than about 45, or less than about 40, or less than about 35, or less than about 30.

In some embodiments, the synthetic graphite particles may further be characterized by having a modified surface. Surface modifications of graphite particles are generally known in the art and include, but are not limited to, surface oxidation (typically rendering the particles more hydrophilic), or, more frequently, a non-graphitic, e.g., amorphous, carbon coating, such as the coatings described in more detail herein below with respect to the second component of the composition (i.e. the coated natural graphite).

Accordingly, in certain embodiments, the synthetic graphite particles comprise a non-graphitic, optionally amorphous, carbon coating, preferably contributing less than about 5%, or less than about 2%, or less than about 1% to the total weight of the synthetic graphite particles.

In addition, the synthetic graphite particles may in some embodiments be formed by agglomerated smaller particles. In some embodiments, the agglomerated particles may additionally be coated, e.g. by one of the coating methods described herein below for the coated natural graphite particles. Graphite made from agglomerated particles is typically characterized by high isotropy.

Synthetic graphite particles having such properties can either be made by processes commonly known in the art, or may even be commercially available. Suitable synthetic graphite particles are for example often specifically marketed as active material for negative electrodes.

The second component of the compositions described herein, i.e. the non-graphitic carbon-coated natural graphite particles, serves as a “booster” or “charge accelerator” of certain performance characteristics of the electrode in, e.g., lithium-ion batteries, in particular higher charging speeds, higher energy density, and increased reversible capacity while not negatively affecting cycling stability.

The non-graphitic natural graphite (cNG) of the composition may optionally be further characterized by one or more of the following parameters.

In certain embodiments, the non-graphitic natural graphite particles may be further characterized by a particle size distribution (PSD) with a D₅₀ of between about 5 μm and about 20 μm. In some embodiments, the PSD D₅₀ value is between about 7 μm and about 15 μm, or between about 10 μm and about 15 μm.

Alternatively or in addition, the D₉₀ value of the cNG particles may be below about 40 μm, or below about 35 μm, or below about 30 μm. In some embodiments, the D₉₀ values of the cNG particles is between about 20 μm and about 40 μm, or between about 25 μm and about 35 μm, or between about 25 μm and about 30 μm. Since even a small amount of large cNG particles in the composition are generally believed to be detrimental to the performance characteristics of the anode, the D₉₉ value of said cNG particles is in preferred embodiments below about 45 μm, or below about 40 μm.

As noted above, the BET SSA of the cNG particles in the composition are generally below 8 m²/g. Preferably, however, the BET SSA of the cNG particles is between about 1.5 m²/g and about 6 m²/g, or between about 2.5 m²/g and about 6 m²/g, or between about 3.5 m²/g and about 5.5 m²/g.

The coated natural graphite particles are preferably of high crystallinity. Accordingly, the cNG particles can in certain embodiments be further characterized, alternatively or in addition, by an interlayer distance c/2 of less than about 0.3357 nm, or less than about 0.3356 nm, or less than about 0.3355 nm.

In some embodiments, the cNG particles may be further characterized by a crystallographic L_{c} value (as measured by XRD) of at least about 90 nm, or at least about 100 nm, or at least about 105 nm. Preferably, the crystallographic L_{c} value of the cNG particles is between about 90 nm and about 200 nm, or between about 100 nm and about 180 nm, or between about 100 nm and about 150 nm.

In addition, the cNG particles should preferably have a spherical or near spherical shape, which may for example be achieved by milling and/or autologous surface treatments generally known in the art, see, e.g., the autologous grinding method described in WO 01/38220 (Timcal AG). Accordingly, the cNG particles may be further characterized, alternatively or in addition, by a high sphericity (S), expressed as a value Q3 (S=0.8) of equal or less than about 30%, or less than about 25%, less than about 20%, or less than about 15%, or less than about 10%. The sphericity (S) is obtained as the ratio of the perimeter of the equivalent circle to the actual perimeter (for details on how to determine this parameter, see the Methods section below).

The coating of the natural graphite particles consists of non-graphitic carbon. Non-graphitic carbon is characterized by a two-dimensional long-range order of the carbon atoms in planar hexagonal networks, but without any measurable crystallographic order in the third direction (c-direction), apart from more or less parallel stacking. Carbon deposited on the surface of particles by pyrolysis is an example of non-graphitic carbon. Due to the absence of a long range order in every dimension, such carbon is often also referred to as amorphous carbon.

Graphite particles coated by non-graphitic/amorphous carbon thus exhibit a lower crystallinity on the surface of the particles compared to the crystallinity of the core. Since the laser used for Raman spectroscopy is only capable to penetrate the upper surface layers of particles, Raman spectroscopy represents a useful method for distinguishing coated or otherwise surface-modified carbon particles from non-coated/unmodified carbon particles.

Accordingly, the non-graphitic carbon-coated natural graphite particles may in certain embodiments be further characterized, alternatively or in addition, by an I_{D}/I_{G} ratio (R(I_{D}/I_{G})) of at least about 0.2, or at least about 0.3, or at least about 0.4, or at least about 0.5, or at least about 0.6, and is typically between about 0.3 and about 1.5, or between about 0.4 and about 1.3, or between about 0.5 and about 1.2, when measured with a laser having an excitation wavelength of 632.8 nm.

In general, the Raman R(I_{D}/I_{G}) value is on the one hand dependent on the nature (and thus ratio) of the starting natural graphite material before the coating, and on the other hand on the nature and thickness of the coating with non-graphitic carbon, as the amorphous carbon on the surface increases the intensity of the D band over the G band (compared to graphitic carbon). For example, the CVD-coated natural graphite particles used in the working examples had R(I_{D}/I_{G}) values of between 0.7 and 1.1, while uncoated, crystalline graphite (whether natural or synthetic) are typically characterized by R(I_{D}/I_{G}) values of way below 0.2, typically below 0.15. Resin or pitch-coated graphites typically have a coating with R(I_{D}/I_{G}) values typically below 0.5 or 0.4 as the coating is less defective compared to a coating applied by CVD.

In some embodiments, the cNG particles can be further characterized, alone or in combination, by a tap density after 400 taps of at least about 0.8 g/cm³, or at least about 0.85 g/cm³, or at least about 0.9 g/cm³, or at least about 0.95 g/cm³.

The coated natural graphite particles used in batteries typically have a high purity. Thus, in many embodiments, the cNG particles may be further characterized by a moisture content of below about 0.05%, or below 0.03% by weight. Similarly, the cNG particles may have an ash content of below about 0.05%, or below 0.03% by weight. The iron (Fe) content is preferably below about 50 ppm, or below 40 ppm, or below 35 ppm (by XRF).

In terms of the non-graphitic coating, the cNG particles may in some embodiments be further characterized, alternatively or in addition, by the thickness of the coating, which may be expressed as weight percentage of the total weight of the particles. Accordingly, in certain embodiments, the non-graphitic carbon coating of said cNG particles of the compositions described herein represents about 0.5% to about 20% (w/w), or about 0.5% to about 10% (w/w), or about 1% to about 5% (w/w) of the total weight of said cNG particles.

The coating of the natural graphite particles can generally be applied by any suitable means known in the art. Coating techniques may be divided into two different groups: one where the non-graphitic/amorphous carbon is directly deposited on the surface of the graphite (or other carbonaceous particles for that matter), and another group where the particles are first coated with a carbon-containing precursor (typically an organic compound having a high carbon content), which is subsequently converted into non-graphitic carbon by heating the particles coated with the carbon precursor to temperatures of at least about 500° C. to about 1200° C. (“carbonization”, or “calcination”) in an inert atmosphere.

Examples for the direct coating include, first and foremost, chemical vapor deposition (CVD), but also include physical vapor deposition (PVD), or plasma spray coating, all of which are generally known to those of skill in this technical field. The second group includes pitch-coating (wherein the carbon-containing precursor is petroleum-based pitch or coal tar pitch), and coating with other organic precursor molecules, e.g., amphiphilic surfactants such as PEO-PPO-PEO block copolymers, polyglycol ethers, alkyl-aryl polyethylene glycol ethers, aryl-ethyl-phenyl polyglycol ethers, aryl polyglycol ether, carboxylic acid polyethylene glycol ester nonionic surfactant, alkyl polyoxyethylene ethers, aryl polyoxyethylene ethers, novolac-based resins such as nonyl phenol novolac ethoxylate, polystyrene methacrylate co-polymers, polyacrylates, polyacrylate co-polymers; alkyl-, phenyl- or polyalkylphenyl sulfonates, sulfated lignins, lignosulfonate salts, or mixtures thereof, as for example described in WO 2015/158741.

Accordingly, in some embodiments the non-graphitic carbon coating of said cNG particles is obtainable by a method selected from CVD coating, PVD coating, plasma coating, pitch-coating, or amphiphilic surfactant-coating, e.g. with one of the surfactants listed above.

Preferably, the non-graphitic carbon coating of said cNG particles is obtained by chemical vapor deposition (CVD). As noted above, such CVD-coated natural graphite particles will exhibit an R(I_{D}/I_{G}) value of at least about 0.4 or at least about 0.5, or at least about 0.6.

For example, the non-graphitic carbon coating may be obtained by chemical vapor deposition of a natural graphite particulate starting material at temperatures from 500 to 1200° C. with a hydrocarbon gas such as acetylene or propylene, typically mixed with an inert carrier gas such as nitrogen or argon, with treatment times typically ranging from 3 to 120 minutes in for example a rotary kiln or fluidized bed. Again, it will be understood that certain adaptations to the process may be necessary (e.g. length of exposure to hydrocarbon gas, choice of hydrocarbon gas and starting material, etc.) in order to obtain a material exhibiting the desired parameters outlined above.

Accordingly, in certain embodiments, the non-graphitic carbon coating of the cNG particles is obtainable by chemical vapor deposition (CVD), optionally by chemical vapor deposition treatment of a natural graphite particulate starting material at temperatures from 500 to 1200° C. with hydrocarbon gas, typically with treatment times ranging from about 3 to about 120 minutes.

In certain embodiments, the cNG particles of the composition may be characterized by having a hydrophilic non-graphitic, such as amorphous, carbon coating. Such a hydrophilic non-graphitic carbon coating can for example be obtained by first coating the natural graphite particles with a layer of non-graphitic carbon (for example by CVD), and subsequently exposing the coated particles to an oxygen-containing gas atmosphere under controlled conditions, as described in PCT/EP2015/066212, which is incorporated herein by reference in its entirety. The exposure to an oxygen-containing atmosphere will increase the hydrophilicity of the graphite particles, and is, for the sake of convenience, also sometimes referred to herein as “activation”, or “surface-oxidation”. Accordingly, the carbon coating of said hydrophilic surface-modified carbonaceous particulate material is in certain embodiments comprised of (partially) oxidized amorphous carbon.

In some of these embodiments, the at least one hydrophilic surface-modified carbonaceous particulate material may be further characterized by an increased wettability, compared to non-oxidized (i.e. non-activated) coated particles.

Suitable methods and resulting hydrophilic surface-modified (coated) carbonaceous particles are for example described in more detail in WO 2016/008951 A1, the disclosure of which is, as noted earlier herein, incorporated by reference in its entirety.

The coated natural graphite particles may in certain embodiments be further characterized by exhibiting a ratio of the crystallographic [004] and [110] reflection intensities (“OI”) for a pressed electrode sheet comprising said graphite particles of more than about 40, or more than about 45, or more than about 50, or more than about 55, or more than about 60, or more than about 65, or more than about 70, or more than about 75, or more than about 80, or more than about 90, or more than about 100. Details about the preparation of the electrode sheet used for determining this parameter are described in the Methods section below (cf. “Coin Cell Test Process”, section “Electrode Preparation”).

As noted above, the weight content of the cNG particles in the composition may vary considerably, depending on the desired properties of the composition and the specifics of the chosen graphite types, but improvements due to the addition of coated natural graphite particles have been observed when the weight content of the cNG particles is between about 5 and about 75%, or between about 5% and about 70% (see Examples, Table 4) based on the total weight of the composition.

In some embodiments, the weight content of the cNG particles is between about 5% and about 65%, or preferably between about 5% and about 60% of the total weight of the composition.

Besides the two graphitic materials (coated natural graphite and synthetic graphite), the compositions described herein in detail above may optionally further comprise at least one further carbonaceous material as an additive. When present in the composition, the content of said at least one carbonaceous additive is typically up to 20%, or up to 10%, or up to 7%, or up to 5% (w/w) of the total composition.

Suitable carbonaceous additives include, but are not limited to, conductive materials such as natural or synthetic graphite (other than the two main components in the composition), coke, exfoliated graphite, graphene, few-layer graphene, graphite fibers, nanographite, graphitized fine coke, non-graphitic carbon, including hard carbon, carbon black, petroleum- or coal based coke, glassy carbon, carbon nanotubes, including single-walled nanotubes (SWNT), multiwalled nanotubes (MWNT), fullerenes, carbon fibers, or mixtures of any of these materials. For example, the composition may in some embodiments further comprise at least one carbonaceous additive selected from carbon black, carbon nanotubes, graphenes or a combination thereof.

It should be understood that the compositions as described herein may in some embodiments also include more than one species of the synthetic graphite (SG) component and/or the coated natural graphite (cNG) component. Thus, it may be possible to use, for example, two or three different coated natural graphite materials (i.e. differing in their parameters within the limits defined herein), or use two or three different species of the synthetic graphite having different properties (within the limits defined herein), or both.

In addition, since the compositions are particularly useful for preparing negative electrodes for lithium-ion batteries, the composition may in certain embodiments further comprise a polymer binder material. Suitable polymer binder materials include styrene butadiene rubber (SBR), acrylonitrile butadiene rubber (NBR), carboxymethyl cellulose (CMC), polyacrylic acid and derivatives, polyvinylidene fluoride (PVDF), or mixtures thereof, typically in an amount of between 1 and 5% by weight.

The compositions may also be further defined by their functional characteristics when used as an active material in negative electrodes of lithium ion batteries.

Accordingly, the composition may in certain embodiments be further characterized by an electrode capacity of at least about 350 mAh/g, or at least about 352 mAh/g, or at least about 353 mAh/g, or at least about 354 mAh/g. Alternatively or in addition, the compositions yield, when used as an active material in negative electrodes of a lithium ion battery, a capacity retention at 2 C (expressed as the ratio of the constant current charge capacity at 2 C versus the constant current charge capacity at 0.1 C) of at least about 20%, or at least about 21%; or at least about 22%. Details for the measurement of this property are given in the Methods section below (“Coin Cell Test Procedure”).

In other embodiments, the compositions, when used as an active material in negative electrodes of a lithium ion battery, yield a constant current (CC) charge ratio at 3 C of at least about 75%, or at least about 80%; and/or a CC charge ratio at 5 C of at least about 60%, or at least about 65%; and/or a CC charge ratio at 7 C of at least about 45% or at least about 50%. Details for the measurement of this property are also given in the Methods section below (cf. “Pouch Cell Test Procedure”).

Alternatively or in addition, the compositions described herein may be further characterized by their improvement of the electrochemical parameters of a cell comprising the composition as an active material in the anode compared to cells wherein the anode is only made by the synthetic graphite component of the composition (i.e. in the absence of the coated natural graphite particles).

For example, in some embodiments, the compositions described herein yield, when used as an active material in negative electrodes of a lithium ion battery, a relative increase in capacity retention at 2 C of at least about 20%, or at least about 25%, or at least about 30% compared to an electrode made with a corresponding composition without the coated natural graphite particles (cNG).

Alternatively or in addition, the compositions described herein yield, when used as an active material in negative electrodes of a lithium ion battery, a relative increase in the CC charge ratio

i) at 3 C of at least about 2%; and/or
ii) at 5 C of at least about 3%; and/or
iii) at 7 C of at least about 10%,
compared to an electrode made with the corresponding composition without the coated natural graphite particles (cNG).

When the graphite compositions described herein are used for preparing negative electrodes, they are typically dispersed in a suitable (inert) liquid medium, such as water or water/lower alcohol (e.g. ethanol) mixtures. Accordingly, another aspect of the present invention relates to a slurry or dispersion of the compositions described herein in a liquid. The liquid (or solvent, although graphite will not dissolve in the “solvent” but will rather be dispersed therein) is typically water or a water/alcohol mixture. Optionally, the slurry or dispersion may further comprise a surfactant to improve the stability of the dispersion.

### Process for Preparing the Compositions of the Present Disclosure

Yet another aspect of the present disclosure relates to a process for making the composition according to the present disclosure, comprising mixing a synthetic graphite (“SG”) as defined herein with a natural graphite coated with non-graphitic carbon (“cNG”) as defined herein, optionally in the presence of a liquid, such as water or a water/alcohol mixture.

Such a process may further comprise adding one or more additives as described above, for example a carbonaceous additive or a polymer binder. Optionally, a surfactant may be added as well. When a solvent is used during the mixing process, the solvent may optionally be removed from the composition after the mixing step.

### Uses for the Compositions

Since the compositions of the present disclosure offer beneficial combined properties as an active material in negative electrodes, e.g. in lithium-ion batteries, the use of the compositions as defined herein for preparing a negative electrode, e.g., for lithium-ion batteries, represents another aspect of the invention. Such lithium-ion batteries are in some embodiments adapted for use in an electric vehicle, a hybrid electric vehicle, a plug-in hybrid electric vehicle, or an energy storage cell.

### Downstream Products Employing the Compositions of the Present Disclosure

An electrode, such as a negative electrode, comprising a composition as defined herein as an active material represents a further aspect of the present disclosure. This includes electrodes where the negative electrodes comprise less than 100% of the carbonaceous particulate material according to the present disclosure as an active material. In other words, negative electrodes containing mixtures with yet other materials (graphite or otherwise) are likewise contemplated as an aspect of the present disclosure.

The present disclosure also relates in another aspect to lithium-ion batteries comprising a composition as defined herein as the active material in the negative electrode of the battery. Again, batteries wherein the negative electrodes contain mixtures with yet other carbonaceous particulate materials are also included in this aspect of the disclosure.

Yet another aspect of the present disclosure relates to an electric vehicle, hybrid electric vehicle, or plug-in hybrid electric vehicle or an energy storage cell comprising a lithium-ion battery, wherein the lithium ion battery comprises a composition as defined herein as an active material in the negative electrode of the battery.

### Other Uses

The present disclosure further relates in another aspect to the use of a natural graphite coated with non-graphitic carbon (cNG) as defined herein for preparing a carbonaceous composition that is suitable for being used as an active material in a negative electrode. As explained above, such active material compositions typically comprise low surface area synthetic graphite, such as the synthetic graphites described in the present disclosure.

The coated natural graphite particles as defined herein were found to act as a “booster”/“charge accelerator” of certain electrochemical properties, such as increasing the energy density and charge rate performance of a lithium-ion battery while maintaining the power density and durability of the cell. Good results have been obtained when the coated natural graphite particles represent between about 5% and about 75%, or between about 10% and about 70%, or between about 15% and about 65% by weight of the total weight of the active material composition.

Accordingly, the use of a natural graphite coated with non-graphitic carbon (cNG) as defined herein as a carbonaceous additive to increase the energy density and charge rate performance of a lithium-ion battery while maintaining the power density of the cell compared to a cell with an anode absent the carbonaceous additive represents another aspect of the present disclosure.

### Measurement Methods

Suitable methods for determining the various properties and parameters used to define the compositions and carbonaceous materials described herein are set out in more detail below.

The percentage (%) values specified herein are by weight, unless specified otherwise.

### Specific BET Surface Area, DFT Micropore and Mesopore Volume and Area

The method is based on the registration of the absorption isotherm of liquid nitrogen in the range p/p0=0.04-0.26, at 77 K. The nitrogen gas adsorption was performed on a Quantachrome Autosorb-1. Following the procedure proposed by Brunauer, Emmet and Teller (Adsorption of Gases in Multimolecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated. The isotherm measured in the pressure range p/p0 0.01-1, at 77 K may be processed with DFT calculation in order to assess the pore size distribution, micro- and mesopore volume and area.
Reference: Ravikovitch, P., Vishnyakov, A., Russo, R., Neimark, A., Langmuir 16 (2000) 2311-2320; Jagiello, J., Thommes, M., Carbon 42 (2004) 1227-1232.

### Particle Size Distribution by Laser Diffraction

The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into the particle size distribution by means of a calculator. The method yields the proportion of the total volume of particles to a discrete number of size classes forming a volumetric particle size distribution (PSD). The particle size distribution is typically defined by the values D₁₀, D₅₀ and D₉₀, wherein 10 percent (by volume) of the particle population has a size below the D₁₀ value, 50 percent (by volume) of the particle population has a size below the D₅₀ value and 90 percent (by volume) of the particle population has a size below the D₉₀ value.

The particle size distribution data by laser diffraction quoted herein were measured with a MALVERN Mastersizer S. For determining the PSD, a small sample of a carbon material was mixed with a few drops of a wetting agent such as the non-ionic surfactant Imbentin PAP/6200 and a small amount of water. The sample prepared in the described manner was introduced in the storage vessel of the apparatus (MALVERN Mastersizer S) and after 5 minutes of ultrasonic treatment at intensity of 100% and the pump and stirrer speed set at 40%, a measurement was taken.
References: ISO 13320 (2009)/ISO 14887

### X-Ray Diffraction

XRD data were collected using a PANalytical X'Pert PRO diffractometer coupled with a PANalytical X'Celerator detector. The diffractometer has following characteristics shown in Table 1:

TABLE 1
Instrument data and measurement parameters

| | |
|---|---|
| Instrument | PANalytical X’Pert PRO |
| X-ray detector | PANalytical X’Celerator |
| X-ray source | Cu-K_{α} |
| Generator parameters | 45 kV-40 mA |
| Scan speed | 0.07°/s (for L_{c} and c/2) |
| | 0.01°/s (for [004]/[110] ratio) |
| Divergence slit | 1° (for L_{c} and c/2) |
| | 2° (for [004]/[110] ratio) |
| Sample spinning | 60 rpm |

The data were analyzed using the PANalytical X′Pert HighScore Plus software.

### Interlayer Spacing c/2

The interlayer space c/2 was determined by X-ray diffractometry. The angular position of the peak maximum of the [002] reflection profiles were determined and, by applying the Bragg equation, the interlayer spacing was calculated (Klug and Alexander, X-ray diffraction Procedures, John Wiley & Sons Inc., New York, London (1967)). To avoid problems due to the low absorption coefficient of carbon, the instrument alignment and non-planarity of the sample, an internal standard, silicon powder, was added to the sample and the graphite peak position was recalculated on the basis of the position of the silicon peak. The graphite sample was mixed with the silicon standard powder by adding a mixture of polyglycol and ethanol. The obtained slurry was subsequently applied on a glass plate by means of a blade with 150 μm spacing and dried.

### Crystallite Size L_{c}

Crystallite size was determined by analysis of the [002] diffraction profile and determining the widths of the peak profiles at the half maximum. The broadening of the peak should be affected by crystallite size as proposed by Scherrer (P. Scherrer, Göttinger Nachrichten 2, 98 (1918)). However, the broadening is also affected by other factors such X-ray absorption, Lorentz polarization and the atomic scattering factor. Several methods have been proposed to take into account these effects by using an internal silicon standard and applying a correction function to the Scherrer equation. For the present disclosure, the method suggested by Iwashita (N. Iwashita, C. Rae Park, H. Fujimoto, M. Shiraishi and M. Inagaki, Carbon 42, 701-714 (2004)) was used. The sample preparation was the same as for the c/2 determination described above.

### Crystallographic Diffraction Peak Intensity Ratio (“OI”)

The OI value denotes the diffraction peak intensity ratio of the (004) and (110) reflections, respectively (“I₍₀₀₄₎/I₍₁₁₀₎”) of a pressed electrode comprising the graphite composition as described herein as an active material. The pressed electrode was prepared in the same manner as described below (“Coin Cell Test Process”).

### Xylene Density

The analysis is based on the principle of liquid exclusion as defined in DIN 51 901. Approx. 2.5 g (accuracy 0.1 mg) of powder was weighed in a 25 ml pycnometer. Xylene was added under vacuum (15 Torr). After a few hours dwell time under normal pressure, the pycnometer was conditioned and weighed. The density represents the ratio of mass and volume. The mass is given by the weight of the sample and the volume is calculated from the difference in weight of the xylene filled pycnometer with and without sample powder. Reference: DIN 51 901

### Tapped Density

100 g of dry graphite powder was carefully poured into a graduated cylinder. Subsequently, the cylinder was fixed on the off-centre shaft-based tapping machine and 400 strokes were run. The reading of the volume was taken and the resulting density calculated.

### Reference: —DIN-ISO 787-11

### Dynamic Image Analysis

The sphericity and the aspect-ratio of the particles of the material can be obtained from an image analysis sensor, which is a combination of particle size and shape analysis. The experiments are performed using a Sympatec QICPIC sensor and a MIXCEL dispersing unit. The material is prepared as a paste with water and a surfactant (liquid detergent). The instrument uses a high speed camera (up to 500 fps) and a pulsed light source to capture clear rear-illuminated images of entrained particles. The measurement time typically varies between 30-60 seconds with an average of more than 500,000 measured particles. Each sample was repeated three times for reproducible measurements. The software program determines all of the parameters for the particles.

### Sphericity

The sphericity, S, is the ratio of the perimeter of the equivalent circle (assuming the particles are circles with a diameter such that it has the same area of the projection area of the particle), P_{EQPC}, to the real perimeter, Pᵣₑₐₗ. The value Q₃ (S=0.8), corresponds to the percentage of particles (by cumulative volume) which have a sphericity of lower than S=0.8. Accordingly, a small percentage indicates a sample with highly spherical particles as the majority of the particles in the sample have a sphericity greater than 0.8.

### Raman Spectroscopy

Raman analyses were performed using LabRAM-ARAMIS Micro-Raman Spectrometer from HORIBA Scientific with a 632.8 nm HeNe LASER.

The I_{D}/I_{G} ratio (“R value”) is based on the ratio of intensities of the so-called band D and band G. These peaks are measured at 1350 cm⁻¹ and 1580 cm⁻¹, respectively, and are characteristic for carbon materials.

### Fe Content

This analysis was performed by an SDAR OES simultaneous emission spectrometer. Graphite powder, ground to a maximum particle size of 80 μm by means of a vibrated mill is compacted to a tablet. The sample was placed onto the excitation stand under argon atmosphere of the spectrometer. Subsequently the fully automatic analysis was initiated.

### Ash Content

A low-walled ceramic crucible was ignited at 800° C. in a muffle furnace and dried in a desiccator. A sample of 10 g of dry powder (accuracy 0.1 mg) was weighed in a low-walled ceramic crucible. The powder was combusted at a temperature of 815° C. to constant weight (at least 8 h). The residue corresponds to the ash content. It is expressed as a percentage of the initial weight of the sample.

References: DIN 51903 and DIN 51701 (dividing process), ASTM C 561-91

### Moisture Content

Moisture content was tested following Japanese standard JIS M8511. Briefly speaking, a 10 g±0.25 g sample was weighted and dried at 107° C. for two hours. The sample was then cooled down in a desiccator. The difference in weight was recorded to calculate the moisture ratio.

### Peel Strength Test

Peel strength test was carried out using Instron. The test was performed as the following. A pressed electrode (1.6 g/cm³) with a width of 28 mm and a length of 21 cm was prepared. A 150 mm-length×35 mm-width double-face tape was set onto the test plate. A metal roller was used to ensure good adhesion of tape to the plate.

The right end of electrode was set onto the tape with the same method. The metal plate was then put onto an Instron® 3343 series apparatus and the left end of electrode was attached to the test clip.
After aligning the electrode strip and test clips in a vertical line direction, peel strength was acquired from a 180° peeling with a peeling speed of 100 mm/min.

### Electrochemical Measurements:

### Electrochemical Measurements

### A) Coin Cell Test Procedure

### Electrode Preparation

The electrodes containing the coated natural graphite booster can be prepared according to the following steps. The resulting electrodes were used for coin cell tests.

Synthetic graphite and booster were weighted and put into a closed container. The powders were then mixed for 5 minutes at low mixing speed. The mixing process can be carried out by various mixers that are used for produce the electrode slurry for coating. For example, a THINKY ARE-310® mixer was used and the mixing speed was 500 rpm.

The water solution of 1 wt % carboxymethyl cellulose (CMC, or the dispersion of conductive carbon) was then added into the container. The container was then subjected to a mixing at 2000 rpm for 5 mins. DI water was added into the container. The container was then again subjected to a mixing with 2000 rpm for 5 mins. Finally, Styrene-Butadiene Rubber (SBR, 48.5 wt %) suspension was added into the container. The container was subjected to a final mixing at 2000 rpm for 5 mins, followed by a degassing process at 2200 rpm for 2 mins.

The resulting slurry had a solid content of 46%. The weight ratio between different components were graphite (SG+cNG booster):CMC:binder=97.5:1.5:1.5. This slurry was then coated onto a 20 μm copper foil and then dried at 80° C. The typical loading mass of graphite was 8 mg/cm². For the coin cell tests, the electrodes were pressed to a density of 1.6 g/cm³.

### Coin Cell Assembly

CR2032 type coin cells were assembled to test the charge rate performance in coin cells. A piece of Li metal was used as both counter and reference electrode. The electrolyte was 200 μl 1M LiPF₆ EC/ECM/DMC(3/5/2 in weight). The separator used was a piece of celgard 2500.

### Charge Rate Performance Test

The coin cells were charged at 2.0 C to 1.5V and at a constant voltage till current dropped to 0.01 C. The cells were then discharged at 0.1 C. The capacity retention at 2 C is the ratio between constant current charged capacities at 2 C versus 0.1 C.

### Description of Laminated Cell Test Procedure

### Electrode Preparation

In a typical run, the electrodes containing the booster can be prepared according to the following steps. These electrodes were used for laminated tests.

For the negative electrode:

Synthetic graphite and booster were weighted and put into mixer machine's container. The powders were then mixed for 5 minutes at low mixing speed. The mixing process can be carried out by various mixers that are used for produce the electrode slurry for coating. For example a Primix 2P-03 type mixer can be used with a mixing speed of 20 rpm.

1 wt. % CMC and 0.5% carbon black (Imerys Cnergy C65) dispersion (was added and mixed at 50 rpm for 30 min. DI water was added to adjust the solid content. The slurry was then mixed at 80 rpm for 30 min. Finally, Styrene-Butadiene Rubber (SBR, 48.5 w.t %) suspension was added into the container. The slurry was stirred at 80 rpm for 30 min and then degassed at 20 rpm for 10 min. The final solid content was 49%.

The weight ratio between different components were graphite (SG+booster): conducting carbon:CMC:binder=97.5:0.5:1.0:1.5.

The resulting slurry was coated onto copper foil using roll to roll coater while drying at 80° C. The loading mass for the material was 5 mg/cm². The electrode material was pressed to a density of 1.6 g/cm³.

### For the Positive Electrode

The preparation of positive electrode used the same mixer as for the negative electrode. The final slurry composition for positive electrode was lithium nickel cobalt manganese oxide: carbon black: binder=96:1:3 with a solid content of 70%. The solvent used in positive electrode preparation was N-Methyl-2-pyrrolidone (NMP).

The slurry was then coated onto Aluminum foil with a roll to roll coater. The drying temperature was 120° C. The loading mass for the material was 10 mg/cm². The electrode material was pressed to a density of 3.0 g/cm³.

### Charge Performance Test of Pouch Cells

30 mAh pouch cells were assembled in a dry room with a dew point of below −40° C. The electrolyte was 1M LiPF6 EC/EMC/DMC(⅓ each in volume) with 1 wt % vinylene carbonate (VC).

The charge rate performance test was carried out by the following steps:

The cells were charged in a constant current-constant voltage (CC-CV) mode to 4.2V. The cells were charged at a constant current of nC (0.2 C, 0.5 C, 1.0 C, 2.0 C, 3.0 C, 5.0 C, 7.0 C respectively) to 4.2V and then charged at 4.2V till the current dropped to 0.01 C. The cells were discharged at 0.5 C to 2.5V. The CC charge capacity ratio was calculated based on the following equation

$$CC charge capacity ratio at nC = \frac{Charge capacity of CC at nC}{Charge capacity of CC + CV}$$

Having described the various aspects of the present disclosure in general terms, it will be apparent to those of skill in the art that many modifications and slight variations are possible without departing from the spirit and scope of the present disclosure.

### EXAMPLES

### Example 1

A variety of compositions comprising a synthetic graphite and a coated natural graphite as defined herein were prepared and then used to prepare electrodes.

The physicochemical properties of the synthetic graphites used in the working examples are summarized in Table 2 below.

TABLE 2
Physicochemical Properties of Synthetic Graphites (SG)

| Synthetic | BET | PSD | PSD | PSD | Tap | c/2 | OI value |
|---|---|---|---|---|---|---|---|
| Graphite | SSA | D₁₀ | D₅₀ | D₉₀ | Density | (nm) | of anode |
| SG1 | 1.7 | 8 | 17 | 34 | 0.94 | 0.3363 | 6.2 |
| SG2 | 1.2 | 5 | 13 | 25 | 0.92 | 0.3359 | 40 |
| SG3 | 1.3 | 7 | 15 | 28 | 1.09 | 0.3360 | 36 |
| SG4 | 1.4 | 9 | 15 | 23 | 1.00 | 0.3358 | 7.1 |

The physicochemical properties of the coated natural graphites used in the working examples are summarized in Tables 3a and 3b below:

TABLE 3a
Physicochemical Properties of Coated Natural Graphites (cNG)

| Coated | | | | | | Tap | |
|---|---|---|---|---|---|---|---|
| Natural | | | | R | BET | Dens- | PSD |
| Graphite | Wt % of | c/2 | L_{c} | (I_{D}/ | SSA | ity | D₅₀ |
| (cNG) | Coating | (nm) | (nm) | I_{G}) | (m²/g) | (g/cm³) | (μm) |
| Booster-1 | 4 | 0.3355 | 108 | 0.7 | 4.0 | 1.1 | 15 |
| Booster-2 | 1 | 0.3354 | 117 | 0.5 | 4.8 | 1.1 | 15 |
| Booster-3 | 4 | 0.3356 | 110 | 1.1 | 4.9 | 1.0 | 10 |
| Booster-4 | 2 | 0.3355 | 118 | 0.9 | 5.4 | 1.0 | 10 |
| Comp. | 1 | 0.3354 | 219 | 0.04 | 2.9 | 1.0 | 17 |
| cNG* | | | | | | | |

*Parameters out of spec of cNGs used in the present disclosure

TABLE 3b
Additional Properties of Coated Natural Graphites (cNG)

| Coated Natural | Wt % of | Moisture | Ash | Fe content from |
|---|---|---|---|---|
| Graphite | Coating | (wt %) | (wt %) | XRF (ppm) |
| Booster-1 | 4 | 0.02 | 0.02 | 26 |
| Booster-2 | 1 | 0.02 | 0.02 | 26 |
| Booster-3 | 4 | 0.01 | 0.02 | 31 |
| Booster-4 | 2 | 0.01 | 0.02 | 31 |

The graphite compositions were mixed together as described in the Methods section above. A slurry comprising the composition with an SG and an cNG was then employed in the preparation of negative electrodes as described in more detail in Example 2.

### Example 2

The electrodes containing the synthetic graphite together with the coated natural graphite booster were prepared according to the following steps.

Synthetic graphite X g and cNG booster Y g were weighted and put into a closed container (X+Y=35 g). The powders were then mixed for 5 minutes at low mixing speed. The mixing process can be carried out by any mixer that is typically employed for producing the slurry for coating the copper foil. In the present case, a THINKY ARE-310 was used at a mixing speed of 500 rpm.

35.9 g of an aqueous solution of carboxymethyl cellulose (CMC, 1 wt %) was then added into the container. The container was then subjected to a mixing step at 2000 rpm for 5 mins. 6 g of DI water was then added into the container and the mixture again subjected to a mixing step at 2000 rpm for 5 mins.

Finally, 1.44 g of styrene-butadiene rubber (SBR, 48.5 wt %) suspension was added into the container and the resulting mixture was then subjected to a mixing step at 2000 rpm for 5 mins and a degassing step at 2200 rpm for 2 mins.

The resulting slurry had a solid content of 46% by weight. The slurry obtained by said procedure was then coated onto a 20 μm copper foil and dried at 80° C. The typical loading mass of graphite was 8 mg/cm². For the coin cell tests, the electrodes were pressed to a density of 1.6 g/cm³.

The electrodes prepared in this manner were used for coin cell tests as described in greater detail below.

### Example 3

The electrodes prepared according to Example 2 were used in coin cell tests to determine the capacity retention at 2 C (the ratio of the constant current charge capacity at 2 C versus the constant current charge capacity at 0.1 C), as described in more detail in the Methods section above (cf. Coin Cell Test Process). The results of the capacity retention experiments for different synthetic graphites and different cNG boosters/concentrations are shown in FIG. 2 and summarized below in Table 4.

TABLE 4
Capacity Retention at 2 C of a Synthetic Graphite Electrode with different
Concentrations of coated Natural Graphite Booster Components

| wt % of Synthetic | | Capacity Retention | Electrode capacity |
|---|---|---|---|
| Graphite (SG1) | cNG Booster | at 2 C (%) | (mAh/g) |
| 100 | — | 15.5 | 342.1 |
| 95 | Booster-1 | 21.7 | 345.0 |
| 90 | Booster-1 | 22.6 | 346.2 |
| 80 | Booster-1 | 23.8 | 346.7 |
| 80 | Booster-2 | 25.9 | 353.7 |
| 80 | Booster-3 | 27.3 | 353.2 |
| 80 | Booster-4 | 30.6 | 354.6 |
| 80 | Comp. cNG | 14.1 | 354.0 |
| 60 | Booster-1 | 24.4 | 352.2 |
| 40 | Booster-1 | 23.0 | 354.4 |
| 20 | Booster-1 | 20.2 | 358.0 |
| 0 | Booster-1 | 11.9 | 360.0 |
| 0 | Comp. cNG | 10.1 | 356.7 |

### Example 4

The was also examined for different synthetic graphite materials to evaluate the dependence of the results on the type and characteristics of the synthetic graphite in the composition. The results for different synthetic graphites (SG1 to SG4) are illustrated in FIG. 3 and summarized below in Table 5.

TABLE 5
Capacity Retention at 2 C for different Synthetic Graphites

| Capacity Retention | | | | |
|---|---|---|---|---|
| at 2 C (%) | SG1 | SG2 | SG3 | SG4 |
| No additive | 15.5 | 14.1 | 17.2 | 18.6 |
| cNG Booster-1 | 22.6 | 17.8 | 21.6 | 23.2 |
| 10 wt % in electrode | | | | |

### Example 5

The influence of the cNG booster material on the charge rate performance of lithium ion batteries were tested in pouch cells as described in more detail in the Methods section. Two synthetic graphites (SG1 and SG4) were used for preparing the electrodes of the pouch cell, and compared to compositions further comprising 10 wt % of a cNG booster material (Booster-1).

After preparing the pouch cells as described above in the Methods section, the charge rate performance test was carried out by charging the cells in a constant current-constant voltage (CC-CV) mode to 4.2V. The cells were then discharged in 0.5 C to 2.5V. The CC charge capacity ratio was calculated based on the following equation

$$CC charge ratio = \frac{Charge capacity of CC}{Charge capacity of CC + CV}$$

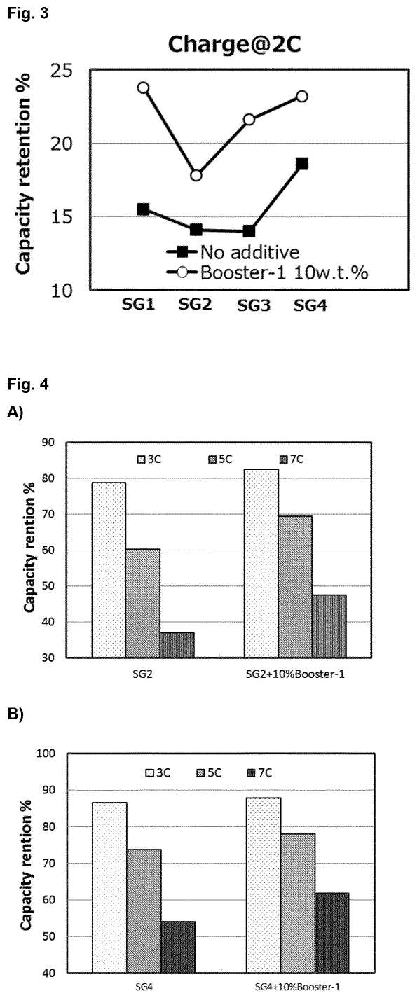

The results for four different compositions are summarized below in Table 6 and are illustrated in FIG. 4 (Panel A comparing SG1 with SG1+10 wt % cNG Booster-1, Panel B comparing SG4 with SG4+10 wt % cNG Booster-1).

TABLE 6
Improvement of CC Charge Ratio at high Charging Rates

| | CC charge ratio | | | |
|---|---|---|---|---|
| | | SG2 + 10% | | SG4 + 10% |
| C rate | SG2 | Booster-1 | SG4 | Booster-1 |
| 0.5 | 95.7 | 96.2 | 97.2 | 97.4 |
| 1 | 91.9 | 93.3 | 95.1 | 95.5 |
| 2 | 85.8 | 88.0 | 90.9 | 91.7 |
| 3 | 78.8 | 82.6 | 86.4 | 87.7 |
| 5 | 60.3 | 69.4 | 73.7 | 78.0 |
| 7 | 36.9 | 47.5 | 54.0 | 61.7 |

### Example 6

Adding various amounts of cNG Booster-3 (20 to 100 wt %) into SG1, electrodes were pressed at the same pressure of 9 kN to a density of 1.6 g/cm³.

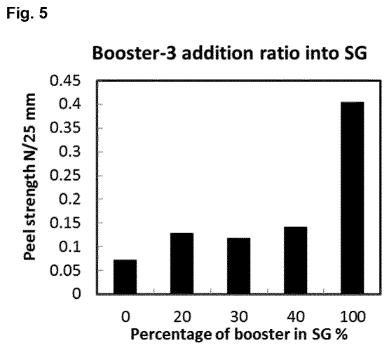

As can be seen from FIG. 5, compared to electrodes made from SG1 alone, adding cNG Booster-3 at a ratio of between 20 wt % and 40 wt % significantly increased the peel strength of the electrode.

1. A composition comprising:
at least one carbonaceous particulate material comprised of synthetic graphite particles (“SG particles”) having a BET SSA of equal to or less than 4 m²/g; and
at least one carbonaceous particulate material comprised of natural graphite particles (“cNG particles”) coated with non-graphitic carbon and having a BET SSA of equal to or less than 8 m²/g;
wherein the composition comprises between about 5% and about 75% cNG particles by weight of the total weight of the composition.

2. The composition according to claim 1, wherein the SG particles are further characterized by
i) a particle size distribution (PSD) with a D₅₀ of between about 10 μm and about 30 μm; and/or
ii) a c/2 distance of between about 0.3354 nm and about 0.3370 nm; and/or
iii) a BET SSA of between about 0.5 m²/g and about 4 m²/g; and/or
iv) a xylene density of at least about 2.22 g/cm³; and/or
v) a tap density after 400 taps of at least about 0.8 g/cm³; and/or
vi) a ratio of the crystallographic [004] and [110] reflection intensities (OI) of less than about 40; and/or
vii) a non-graphitic carbon coating, wherein the non-graphitic carbon coating comprises less than about 2% by weight of the particle.

3. The composition according to claim 1, wherein the cNG particles are further characterized by
i) a particle size distribution (PSD) with a D₅₀ of between about 5 μm and about 20 μm; and/or
ii) a PSD with a D₉₀ of equal to or less than about 40 μm; and/or
iii) an I_{D}/I_{G} ratio (R(I_{D}/I_{G})) of between about 0.2 and about 1.5 when measured with a laser having an excitation wavelength of 632.8 nm; and/or
iv) a c/2 distance of less than about 0.3356 nm; and/or
v) a crystallographic L_{c} value (as measured by XRD) of at least about 90 nm.

4. The composition according to claim 3, wherein the cNG particles are further characterized by
vi) a BET SSA of between about 1.5 m²/g and about 6 m²/g; and/or
vii) a tapped density after 400 taps of at least about 0.8 g/cm³; and/or
viii) a crystallographic L_{c} value (as measured by XRD) of between about 100 nm and about 180 nm; and/or
ix) a ratio of the crystallographic [004] and [110] reflection intensities (OI) of more than about 45, or more than about 50; and/or
x) a sphericity expressed as Q3^{(S=0.8)} of equal or less than about 30%

5. The composition according to claim 1, wherein the non-graphitic carbon coating of said cNG particles comprises about 0.5% to about 20% by weight of the total weight of said cNG particles.

6. The composition according to claim 5, wherein the non-graphitic carbon coating of said cNG particles is obtainable by a method selected from CVD coating, PVD coating, plasma coating, pitch-coating, or amphiphilic surfactant-coating.

7. The composition according to claim 5, wherein the non-graphitic carbon coating of said cNG particles is obtainable by chemical vapor deposition treatment of a carbonaceous particulate starting material at temperatures from 500 to 1200° C. with hydrocarbon gas and treatment times ranging from about 3 to about 120 minutes.

8. The composition according to claim 1, wherein the weight content of the cNG particles is between about 5% and about 60% of the total weight of the composition.

9. The composition according to claim 1, wherein the composition comprises one or more additives selected from
i) up to 10% by weight carbon black, carbon nanotubes, graphene or a combination thereof; and
ii) styrene butadiene rubber (SBR), acrylonitrile butadiene rubber (NBR), carboxymethyl cellulose (CMC), polyacrylic acid or derivatives thereof, polyvinylidene fluoride (PVDF), or mixtures thereof.

10. The composition according to claim 1, yielding, when the composition is used as a negative electrode active material,
i) an electrode capacity of at least about 350 mAh/g, or at least about 352 mAh/g; and/or
ii) a capacity retention at 2 C of at least about 20%, or at least about 21%; and/or
iii) a relative increase in capacity retention at 2 C, compared to an electrode made without said cNG, of at least about 20%; and/or
iv) a constant current (CC) charge ratio at 3 C of at least about 75%; and/or
v) a constant current (CC) charge ratio at 5 C of at least about 60%; and/or
vi) a constant current (CC) charge ratio at 7 C of at least about 45%; and/or
vi) a relative increase in the CC charge ratio at 3 C, compared to an electrode made without said cNG, of at least about 2%; and/or
vii) a relative increase in the CC charge ratio at 5 C, compared to an electrode made without said cNG, of at least about 3%; and/or
viii) a relative increase in the CC charge ratio at 7 C, compared to an electrode made without said cNG, of at least about 10%.

11. A slurry comprising the composition according to claim 1 and water or a water/alcohol mixture.

12. A process for making a composition, the process comprising mixing a synthetic graphite particles having a BET SSA of equal or less than 4 m2/g (“SG”) with natural graphite particles coated with non-graphitic carbon and having a BET SSA of equal to or less than 8 m2/g.

13. The process according to claim 12, further comprising adding:
carbon black, carbon nanotubes, and/or graphene; and
styrene butadiene rubber (SBR), acrylonitrile butadiene rubber (NBR), carboxymethyl cellulose (CMC), polyacrylic acid or derivatives thereof, and/or polyvinylidene fluoride (PVDF).

14. A negative electrode of a lithium-ion battery comprising the composition according to claim 1, wherein the lithium-ion battery is to be used in an electric vehicle, a hybrid electric vehicle, or an energy storage cell.

15. (canceled)

16. (canceled)

17. An electrode comprising the composition according to claim 1.

18. A lithium-ion battery comprising an anode that comprises the composition according to claim 1.

19. An electric vehicle, a hybrid electric vehicle, or an energy storage cell comprising a lithium-ion battery according to claim 18.

20. The composition according to claim 1, wherein
the SG particles are further characterized by a particle size distribution (PSD) with a D50 of between about 10 μm and about 30 μm; and
the cNG particles are further characterized by a particle size distribution (PSD) with a D50 of between about 5 μm and about 20 μm and a D90 of equal to or less than about 40 μm.

21. The composition according to claim 20, wherein
the SG particles are further characterized by:
a c/2 distance of between about 0.3354 nm and about 0.3370 nm;
a BET SSA of between about 0.5 m²/g and about 4 m²/g;
a xylene density of at least about 2.22 g/cm³;
a tap density after 400 taps of at least about 0.8 g/cm³;
a ratio of the crystallographic [004] and [110] reflection intensities (OI) of less than about 40; and
a non-graphitic carbon coating, wherein the non-graphitic carbon coating comprises less than about 2% by weight of the particle; and
the cNG particles are further characterized by:
a BET SSA of between about 1.5 m2/g and about 6 m2/g;
a tapped density after 400 taps of at least about 0.8 g/cm3;
a ratio of the crystallographic [004] and [110] reflection intensities (OI) of more than about 45;
a sphericity expressed as Q3(S=0.8) of equal or less than about 30;
a crystallographic Lc value (as measured by XRD) of between about 100 nm and about 180 nm;
an ID/IG ratio (R(ID/IG)) of between about 0.2 and about 1.5 when measured with a laser having an excitation wavelength of 632.8 nm; and
a c/2 distance of less than about 0.3356 nm.
